(19) United States
(12) Patent Application Publication
(10) Pub. No.: US 2022/0073686 A1
(43) Pub. Date: Mar. 10, 2022

(54) COPOLYMER POWDER WITH POLYAMIDE BLOCKS AND POLYETHER BLOCKS

(71) Applicant: Arkema France, Colombes (FR)

(72) Inventors: Geoffroy CAMMAGE, SERQUIGNY (FR); Bertrand PERRIN, SINGAPORE (SG)

(73) Assignee: Arkema France, Colombes (FR)

(21) Appl. No.: 17/312,997

(22) PCT Filed: Dec. 11, 2019
(86) PCT No.: PCT/FR2019/053009

§ 371 Date: Jun. 11, 2021

(30) Foreign Application Priority Data
Dec. 13, 2018 (FR) 1872828

(51) Int. Cl. C08J 3/14; C08K 5/05; C08G 65/08; C08G 65/20; C08G 69/14; C08G 69/26; B29C 64/153

(52) U.S. Cl. CPC C08J 3/14; C08K 5/05; C08G 65/08; C08G 65/20; C08G 69/14; B33Y 10/00; B29C 64/153; C08J 2371/02; C08J 2377/02; C08J 2377/06; C08G 69/26

(57) ABSTRACT

The invention relates to a copolymer powder containing polyamide blocks and polyether blocks having:
an enthalpy of fusion of the polyamide blocks of greater than or equal to 70 J/g if the weight ratio of the polyamide blocks relative to the polyether blocks of the copolymer is greater than or equal to 4;
an enthalpy of fusion of the polyamide blocks of greater than or equal to 50 J/g if the weight ratio of the polyamide blocks relative to the polyether blocks of the copolymer is greater than or equal to 1 and less than 4; or
an enthalpy of fusion of the polyamide blocks of greater than or equal to 20 J/g if the weight ratio of the polyamide blocks relative to the polyether blocks of the copolymer is less than 1.

### FIELD OF THE INVENTION

The present invention relates to a copolymer powder containing polyamide blocks and polyether blocks, and also to the process for manufacturing same. The invention also relates to the use of this powder and to articles manufactured therefrom.

### TECHNICAL BACKGROUND

Copolymers containing polyamide blocks and polyether blocks or “Polyether-Block-Amides” (PEBAs) are plasticizer-free thermoplastic elastomers which belong to the family of engineering polymers. They can be easily processed by injection molding and extrusion of profiles or films. They can also be used in the form of filaments, yarns and fibers for woven fabrics and nonwovens. They are used in the field of sport in particular as components of sports shoe soles or of golf balls, in the medical field in particular in catheters, angioplasty balloons, peristaltic belts, or in motor vehicles, in particular as synthetic leather, skins, dashboard, airbag component.

PEBAs, sold under the name Pebax® by Arkema, make it possible to combine, in the same polymer, unequalled mechanical properties with very good resistance to thermal or UV aging, and also low density. They thus allow the production of light and flexible parts. In particular, at equivalent hardness, they dissipate less energy than other materials, which gives them very good resistance to dynamic flexural or tensile stresses, and they have exceptional elastic return properties.

These polymers can also be used in the field of construction of three-dimensional articles by laser sintering. According to this process, a polymer powder layer is selectively and briefly irradiated in a chamber with a laser beam, the result being that the powder particles impacted by the laser beam melt. The molten particles coalesce and solidify rapidly leading to the formation of a solid mass. This process can simply and rapidly produce three-dimensional articles by repeated irradiation of a succession of freshly applied powder layers.

Document EP 0 968 080 describes a powder used for the laser sintering construction of flexible articles at relatively low temperatures. The powder can, inter alia, comprise a PEBA copolymer.

Document EP 1 663 622 describes a process for manufacturing an article by laser sintering using a thermoplastic composition. The aim of this document is to obtain flexible articles having high strength and durability. The composition used in this document can, inter alia, comprise a PEBA copolymer.

Document EP 2 543 701 describes particles of an inorganic material covered with a polymer which can be chosen from a polyolefin, a polyamide, a polyether ketone, polystyrene, etc. This document also describes a method for preparing these particles, the method comprising dissolving the polymer in a solvent and precipitating the polymer in the presence of a suspension of particles of inorganic material.

Document U.S. Pat. No. 6,245,281 describes a layer-by-layer process for constructing three-dimensional articles by sintering, using a polyamide 12 powder with specific characteristics which make it possible to obtain articles having improved properties.

Document US 2008/0166496 describes a polymer powder comprising polyamide 11 having specific properties, and also a layer-by-layer process for manufacturing three-dimensional articles by sintering from this powder, so as to obtain good-quality three-dimensional articles.

Document WO 2018/075530 describes a polymer used for the manufacture of an article by three-dimensional printing, the polymer possibly comprising PEBA, thermoplastic polyurethane and/or a thermoplastic olefin. This polymer is synthesized by chemical precipitation in order to obtain a polymer powder which exhibits improved properties.

One drawback of the laser sintering process is that if the temperature in the chamber containing the powder is not maintained at a relatively high level but just below the melting temperature of the polymer, distortion of the previously melted portion may take place, causing some protrusion of the construction plane. Thus, when applying the next powder layer, the protruding regions could be offset or even broken.

In addition, the conduction of heat from the irradiated region of the layer to the non-irradiated regions can lead to the formation of three-dimensional articles having a deteriorated resolution.

It is therefore in practice necessary to maintain the temperature of the chamber containing the powder at a relatively high level. But, depending on the properties of the powder used, this can cause resolution problems between the areas intended to be melted and those not intended to be melted.

There is therefore a real need to provide a PEBA powder that enables the construction of three-dimensional articles by laser sintering which are characterized by a good-quality surface and also precise and well-defined dimensions and contours.

### SUMMARY OF THE INVENTION

The invention relates firstly to a copolymer powder containing polyamide blocks and polyether blocks having:
an enthalpy of fusion of the polyamide blocks of greater than or equal to 70 J/g if the weight ratio of the polyamide blocks relative to the polyether blocks of the copolymer is greater than or equal to 4;
an enthalpy of fusion of the polyamide blocks of greater than or equal to 50 J/g if the weight ratio of the polyamide blocks relative to the polyether blocks of the copolymer is greater than or equal to 1 and less than 4; or
an enthalpy of fusion of the polyamide blocks of greater than or equal to 20 J/g if the weight ratio of the polyamide blocks relative to the polyether blocks of the copolymer is less than 1.

In some embodiments, the polyamide blocks of the copolymer are blocks of polyamide 11, or of polyamide 12, or of polyamide 6, or of polyamide 10.10, or of polyamide 10.12, or of polyamide 6.10; and/or the polyether blocks of the copolymer are blocks of polyethylene glycol or of polytetrahydrofuran.

In some embodiments, the polyamide blocks have a number-average molar mass of from 600 to 6000, preferably from 1000 to 2000; and/or the polyether blocks have a number-average molar mass of from 250 to 2000, preferably from 650 to 1500.

In some embodiments, the weight ratio of the polyamide blocks relative to the polyether blocks of the copolymer is from 2 to 19, preferably from 4 to 10.

In some embodiments, the powder is in the form of spheroidal particles having a Dv50 size of from 20 to 150 μm, and preferably from 40 to 80 μm.

In some embodiments, the copolymer containing polyamide blocks and polyether blocks comprises ester bonds between the polyamide blocks and the polyether blocks.

In some embodiments, the powder has an enthalpy of fusion of the polyamide blocks of greater than or equal to 70 J/g, preferably greater than or equal to 80 J/g, more preferably greater than or equal to 90 J/g, more preferably greater than or equal to 100 J/g.

The invention also relates to a process for manufacturing the above powder, comprising:
supplying a copolymer containing polyamide blocks and polyether blocks;
bringing the copolymer into contact with a solvent to obtain a mixture;
heating the mixture in order to dissolve the copolymer in the solvent; and
cooling the mixture in order to obtain a precipitated copolymer in powder form.

In some embodiments, the solvent which is brought into contact with the copolymer is ethanol.

In some embodiments, the heating of the mixture is carried out at a temperature of from 100° C. to 160° C., and preferably from 120° C. to 150° C.; and/or the heating of the mixture has a duration of from 1 to 6 hours, and preferably from 1 to 3 hours.

In some embodiments, the cooling of the mixture is carried out at a rate of 10° C. to 100° C. per hour and preferably of 10° C. to 60° C. per hour.

In some embodiments, an amount of polyamide, preferably polyamide 11, polyamide 12, polyamide 6, or polyamide 10.10, or polyamide 10.12, or polyamide 6.10, not exceeding 20% by weight of the copolymer, is introduced before the cooling of the mixture.

In some embodiments, the process further comprises a step of drying the copolymer powder after the cooling of the mixture, preferably at a temperature of from 10° C. to 150° C.

In some embodiments, the drying of the copolymer powder is carried out at a pressure of from 10 mbar to atmospheric pressure.

The invention also relates to the use of the above powder, for the layer-by-layer construction of a three-dimensional article by sintering of the powder brought about by electromagnetic radiation.

The invention also relates to a three-dimensional article manufactured from the above powder, preferably by layer-by-layer construction by sintering of the powder brought about by electromagnetic radiation.

The present invention makes it possible to overcome the drawbacks of the prior art. More particularly, it provides a PEBA powder that enables the construction of three-dimensional articles by laser sintering which are characterized by a good-quality surface and also precise and well-defined dimensions and contours.

This is accomplished by providing a PEBA powder that has a relatively high enthalpy of fusion for the polyamide blocks, enabling the construction of good-quality, high-resolution three-dimensional articles. The high enthalpy of fusion of the polyamide blocks enables the polymer to remain in its crystalline state when heated prior to laser sintering. Thus, the polymer particles withstand softening and premature agglomeration prior to laser sintering, and the three-dimensional articles obtained have improved resolution.

The value of the enthalpy of fusion of the powder of the invention depends on the weight ratio of the polyamide blocks relative to the polyether blocks. However, for a given grade of PEBA, that is to say for a given weight ratio of the polyamide blocks relative to the polyether blocks, the enthalpy of fusion of the powder of the invention is higher than that of a conventional PEBA, owing to the powder preparation process which is described above.

It should be noted that the melting of the polyether blocks is either not detectable during a differential scanning calorimetry measurement, or, when the concentration of polyamide blocks is relatively high, is detectable but is generally below 0° C., and therefore irrelevant for the main applications targeted by the invention.

### DETAILED DESCRIPTION

The invention is now described in greater detail and in a nonlimiting manner in the description that follows.

### Copolymer

The invention uses a copolymer containing polyamide (PA) blocks and polyether (PE) blocks, or “PEBA” copolymer.

Preferably, it is a linear (non-crosslinked) copolymer.

PEBAs result from the polycondensation of polyamide blocks bearing reactive ends with polyether blocks bearing reactive ends, such as, inter alia, the polycondensation:

1) of polyamide blocks bearing diamine chain ends with polyoxyalkylene blocks bearing dicarboxylic chain ends;

2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols;

3) of polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexyldicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid (or lactam) residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexyldicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene α,ω-diacids. As examples of aromatic diacids, mention may be made of terephthalic acid (T) and isophthalic acid (I). As examples of cycloaliphatic diamines, mention may be made of the isomers bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12, in which 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 11, PA 12, PA 6.10, PA 10.10 or PA 10.12 blocks, or mixtures or copolymers thereof.

The polyether blocks are formed from alkylene oxide units.

The polyether blocks may notably be PEG (polyethylene glycol) blocks, i.e. blocks formed from ethylene oxide units, and/or PPG (propylene glycol) blocks, i.e. blocks formed from propylene oxide units, and/or PO3G (polytrimethylene glycol) blocks, i.e. blocks formed from polytrimethylene glycol ether units, and/or PTMG blocks, i.e. blocks formed from tetramethylene glycol units, also known as polytetrahydrofuran. The PEBA copolymers may comprise in their chain several types of polyethers, the copolyethers possibly being in block or random form.

Use may also be made of blocks obtained by oxyethylation of bisphenols, for instance bisphenol A. The latter products are notably described in document EP 613 919.

The polyether blocks may also be formed from ethoxylated primary amines. As examples of ethoxylated primary amines, mention may be made of the products of formula:

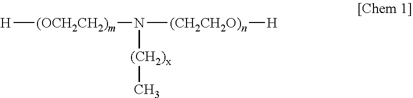

in which m and n are integers between 1 and 20, and x is an integer between 8 and 18. These products are, for example, commercially available under the brand name Noramox® from the company CECA and under the brand name Genamin® from the company Clariant.

The polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the commercial products Jeffamine or Elastamine may be used (for example Jeffamine® D400, D2000, ED 2003, XTJ 542, which are commercial products from the company Huntsman, also described in documents JP 2004/346274, JP 2004/352794 and EP 1482011).

The polyether diol blocks are either used in unmodified form and copolycondensed with polyamide blocks bearing carboxylic end groups, or are aminated to be converted into polyetherdiamines and condensed with polyamide blocks bearing carboxylic end groups.

A general method for the two-step preparation of PEBA copolymers containing ester bonds between the PA blocks and the PE blocks is known and is described, for example, in document FR 2846332. A general method for the preparation of PEBA copolymers containing amide bonds between the PA blocks and the PE blocks is known and described, for example, in document EP 1482011. The polyether blocks may also be mixed with polyamide precursors and a diacid chain limiter to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® PEBA type products sold by Sanyo or to any other PEBA from other suppliers.

If the block copolymers described above generally comprise at least one polyamide block and at least one polyether block, the present invention also covers all the copolymers comprising two, three, four (or even more) different blocks chosen from those described in the present description, provided that these blocks include at least polyamide and polyether blocks.

For example, the copolymer according to the invention may comprise a segmented block copolymer comprising three different types of blocks (or “triblock” copolymer), which results from the condensation of several of the blocks described above. Said triblock copolymer is preferably chosen from copolyetherester amides and copolyether amide urethanes.

PEBA copolymers that are particularly preferred in the context of the invention are copolymers including blocks from among:
PA 11 and PEG;
PA 11 and PTMG;
PA 12 and PEG;
PA 12 and PTMG;
PA 6.10 and PEG;
PA 6.10 and PTMG;
PA 10.10 and PEG;
PA 10.10 and PTMG;
PA 10.12 and PEG;
PA 10.12 and PTMG;
PA 6 and PEG;
PA 6 and PTMG.

In certain embodiments, the number-average molar mass of the polyamide blocks in the PEBA copolymer is from 600 to 6000 g/mol, or from 1000 to 2000 g/mol.

Thus, the polyamide blocks in the PEBA copolymer can have a number-average molar mass of from 600 to 700 g/mol; or from 700 to 800 g/mol; or from 800 to 900 g/mol; or from 900 to 1000 g/mol; or from 1000 to 1500 g/mol; or from 1500 to 2000 g/mol; or 2000 to 2500 g/mol; or from 2500 to 3000 g/mol; or 3000 to 3500 g/mol; or 3500 to 4000 g/mol; or 4000 to 4500 g/mol; or from 4500 to 5000 g/mol; or 5000 to 5500 g/mol; or from 5500 to 6000 g/mol.

In certain embodiments, the number-average molar mass of the polyether blocks in the PEBA copolymer is from 250 to 2000 g/mol, or from 650 to 1500 g/mol.

Thus, the polyether blocks in the PEBA copolymer can have a number-average molar mass of from 250 to 300 g/mol; or from 300 to 400 g/mol; or from 400 to 500 g/mol; or from 500 to 600 g/mol; or from 600 to 700 g/mol; or from 700 to 800 g/mol; or 800 to 900 g/mol; or from 900 to 1000 g/mol; or 1000 to 1500 g/mol; or from 1500 to 2000 g/mol.

The weight ratio of the polyamide blocks relative to the polyether blocks of the PEBA copolymer may in particular be from 0.1 to 20. This ratio by weight can be calculated by dividing the number-average molar mass of the polyamide blocks by the number-average molar mass of the polyether blocks.

Thus, the weight ratio of the polyamide blocks relative to the polyether blocks of the PEBA copolymer can be from 0.1 to 0.2; or from 0.2 to 0.3; or from 0.3 to 0.4; or from 0.4 to 0.5; or from 0.5 to 1; or from 1 to 2; or from 2 to 3; or from 3 to 4; or from 4 to 5; or from 5 to 7; or from 7 to 10; or from 10 to 13; or from 13 to 16; or from 16 to 19; or greater than 19.

Ranges from 2 to 19, and more specifically from 4 to 10, are particularly preferred.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

Preferably, the copolymer used in the invention has an instantaneous hardness of from 25 to 80 Shore D, and preferably of from 50 to 80 Shore D. The hardness measurements can be carried out according to the standard ISO 868:2003.

### Process for Manufacturing the Copolymer Powder

The powder of the invention comprises a PEBA copolymer as described above: preferably a single copolymer is used. It is, however, possible to use a mixture of two or more than two PEBA copolymers as described above.

The copolymer powder according to the invention can be prepared by carrying out a manufacturing process which comprises the following steps:
supplying a copolymer containing polyamide blocks and polyether blocks, for example in the form of granules;
bringing the copolymer into contact with a solvent to obtain a mixture;
heating the mixture in order to dissolve the copolymer in the solvent; and
cooling the mixture in order to obtain the precipitated copolymer in powder form.

The copolymer containing polyamide blocks and polyether blocks is as defined above.

In certain embodiments, the solvent which is brought into contact with the copolymer can be chosen from: ethanol, propanol, butanol, isopropanol, heptanol, formic acid, acetic acid, N-methylpyrrolidone, N-butylpyrrolidone, butyrolactam, caprolactam.

Preferably, the solvent which is brought into contact with the copolymer is technical-grade 96% ethanol (containing water and denatured with butanone and with propan-2-ol).

The copolymer can have a weight fraction in the solvent of from 0.05 to 0.5; and preferably from 0.1 to 0.3. It can in particular have a weight fraction of from 0.05 to 0.1; or from 0.1 to 0.15 or from 0.15 to 0.2; or from 0.2 to 0.25; or from 0.25 to 0.3; or from 0.3 to 0.35 or from 0.35 to 0.4; or from 0.4 to 0.45; or from 0.45 to 0.5.

Surprisingly, it has been observed that the PEBAs are not significantly depolymerized in the presence of ethanol, unlike what has been observed in the presence of other solvents such as methanol or water.

The heating of the mixture can in particular be carried out at a temperature of from 100° C. to 160° C., and preferably from 120° C. to 150° C.

In certain embodiments, the heating of the mixture can for example be carried out at a temperature of from 100° C. to 105° C.; or from 105° C. to 110° C.; or from 110° C. to 115° C.; or from 115° C. to 120° C.; or from 120° C. to 125° C.; or from 125° C. to 130° C.; or from 130° C. to 135° C.; or from 135° C. to 140° C.; or from 140° C. to 145° C.; or from 145° C. to 150° C.; or from 150° C. to 155° C.; or from 155° C. to 160° C.

In certain embodiments, the heating of the mixture at a temperature of from 100° C. to 160° C. may have a duration of from 1 to 6 hours, and preferably from 1 to 3 hours. Thus, the heating of the mixture at a temperature of from 120° C. to 160° C. can last from 1 hour to 1 hour and 30 minutes; or from 1 hour and 30 minutes to 2 hours; or from 2 hours to 2 hours and 30 minutes; or from 2 hours and 30 minutes to 3 hours; or from 3 hours to 3 hours and 30 minutes; or from 3 hours and 30 minutes to 4 hours; or from 4 hours to 4 hours and 30 minutes; or from 4 hours and 30 minutes to 5 hours; or from 5 hours to 5 hours and 30 minutes; or from 5 hours and 30 minutes to 6 hours.

In certain embodiments, the heating comprises at least one step in which the temperature increases in order to reach a maximum temperature of from 100° C. to 160° C.

In certain embodiments, the heating comprises at least one step in which the temperature remains essentially constant at a value lying in the range of from 100° C. to 160° C.

Then, the mixture is cooled in order to bring about the crystallization and thus the precipitation of the copolymer in powder form. This cooling can be carried out down to a temperature above or equal to 50° C. Thus, the cooling can for example be carried out down to a temperature of from 50° C. to 60° C.; or from 60° C. to 70° C.; or from 70° C. to 80° C.; or from 80° C. to 90° C.

Furthermore, this cooling can be carried out at a rate of from 10° C. to 100° C. per hour, preferably from 10° C. to 60° C. per hour, and more preferably from 40° C. to 55° C. per hour. For example the cooling can be carried out with a rate of from 10° C. to 15° C. per hour; or from 15° C. to 20° C. per hour; or from 20° C. to 25° C. per hour; or from 25° C. to 30° C. per hour; or from 30° C. to 35° C. per hour; or from 35° C. to 40° C. per hour; or from 40° C. to 45° C. per hour; or from 45° C. to 50° C. per hour; or from 50° C. to 55° C. per hour; or from 55° C. to 60° C. per hour; or from 60° C. to 65° C. per hour; or from 65° C. to 70° C. per hour; or from 70° C. to 75° C. per hour; or from 75° C. to 80° C. per hour; or from 80° C. to 85° C. per hour; or from 85° C. to 90° C. per hour; or from 90° C. to 95° C. per hour; or from 95° C. to 100° C. per hour.

In certain embodiments, and in order to promote the precipitation, an amount of polyamide can be introduced before the cooling of the mixture. Preferably, this amount of polyamide is less than or equal to 20% by mass, and preferably less than or equal to 10% by mass of the copolymer. The polyamide can in particular be chosen from polyamide 11, polyamide 12, polyamide 6, polyamide 10.10, polyamide 10.12 and polyamide 6.10.

Thus, the added amount of polyamide can be from 0.1% to 1% by mass; or from 1% to 2% by mass; or from 2% to 3% by mass; or 3% to 4% by mass; or from 4% to 5% by mass; or from 5% to 8% by mass; or from 8% to 12% by mass; or from 12% to 16% by mass; or from 16% to 20% by mass of the copolymer.

The process for manufacturing PEBA powder can also comprise a step of drying the copolymer powder after the cooling of the mixture. The drying step can for example be carried out in a drying oven.

In certain embodiments, the drying can be carried out at a temperature of from 10° C. to 150° C., preferably from 25° C. to 85° C., and more preferably from 70° C. to 80° C. The drying can for example be carried out at a temperature of from 10° C. to 20° C.; or from 20° C. to 30° C.; or from 30° C. to 40° C.; or from 40° C. to 50° C.; or from 50° C. to 60° C.; or from 60° C. to 70° C.; or from 70° C. to 80° C.; or from 80° C. to 90° C.; or from 90° C. to 100° C.; or from 100° C. to 110° C.; or from 110° C. to 120° C.; or from 120° C. to 130° C.; or from 130° C. to 140° C.; or from 140° C. to 150° C.; or from 150° C. to 160° C.

In certain embodiments, the drying can be carried out under vacuum at a pressure of greater than 10 mbar; preferably greater than 50 mbar. Thus, the drying can be carried out at a pressure of from 10 to 50 mbar; from 50 to 100 mbar; from 100 to 150 mbar; from 150 to 200 mbar; from 200 to 250 mbar; or from 250 to 300 mbar; or from 300 to 400 mbar; or from 400 to 500 mbar; or from 500 to 600 mbar; or from 600 to 700 mbar; or from 700 to 800 mbar; or from 800 to 900 mbar; or from 900 mbar to less than 1 bar.

Alternatively, the drying can be carried out under atmospheric pressure.

### Copolymer Powder

The copolymer powder containing polyamide blocks and polyether blocks has:
an enthalpy of fusion of the polyamide blocks of greater than or equal to 70 J/g when the weight ratio of the polyamide blocks relative to the polyether blocks of the PEBA copolymer is greater than or equal to 4;
an enthalpy of fusion of the polyamide blocks of greater than or equal to 50 J/g when the weight ratio of the polyamide blocks relative to the polyether blocks of the PEBA copolymer is greater than or equal to 1 and less than 4;
an enthalpy of fusion of the polyamide blocks of greater than or equal to 20 J/g when the weight ratio of the polyamide blocks relative to the polyether blocks of the PEBA copolymer is less than 1.

Differential scanning calorimetry (DSC) analysis of the powders is carried out according to the standard ISO 11357-3, the enthalpy of fusion being directly proportional to the degree of crystallinity of the polymer.

The powder according to the invention preferably has the characteristics of the initial copolymer as presented above, such as for example the number-average molar masses of polyamide blocks and of polyether blocks, and the weight ratio of polyamide blocks relative to the polyether blocks.

In certain embodiments, and when the weight ratio of the polyamide blocks relative to the polyether blocks of the PEBA copolymer is greater than or equal to 4, and more preferably when this ratio is greater than or equal to 8, the PEBA powder has an enthalpy of fusion of the polyamide blocks of greater than or equal to 80 J/g, preferably greater than or equal to 90 J/g, more preferably greater than or equal to 100 J/g. This enthalpy of fusion may for example be from 70 to 75 J/g; or from 75 to 80 J/g; or from 80 to 85 J/g; or from 85 to 90 J/g; or from 90 to 95 J/g; or from 95 to 100 J/g; or from 100 to 110 J/g; or from 110 to 120 J/g; or greater than 120 J/g.

When the weight ratio of the polyamide blocks relative to the polyether blocks of the PEBA copolymer is greater than or equal to 4 and less than 8, the PEBA powder may have an enthalpy of fusion of the polyamide blocks of greater than or equal to 70 J/g, and for example of from 70 to 80 J/g.

Alternatively, when the weight ratio of the polyamide blocks relative to the polyether blocks of the PEBA copolymer is greater than or equal to 8, the PEBA powder may in particular have an enthalpy of fusion of the polyamide blocks of greater than or equal to 80 J/g.

In certain embodiments, and when the weight ratio of the polyamide blocks relative to the polyether blocks of the PEBA copolymer is greater than or equal to 1 and less than 4, the PEBA powder has an enthalpy of fusion of the polyamide blocks of greater than or equal to 60 J/g, preferably greater than or equal to 70 J/g. This enthalpy of fusion may for example be from 50 to 55 J/g; or from 55 to 60 J/g; or from 60 to 65 J/g; or from 65 to 70 J/g; or from 70 to 75 J/g; or from 75 to 80 J/g; or from 80 to 85 J/g; or from 85 to 90 J/g.

In certain embodiments, and when the weight ratio of the polyamide blocks relative to the polyether blocks of the PEBA copolymer is less than 1, the PEBA powder has an enthalpy of fusion of the polyamide blocks of greater than or equal to 30 J/g, preferably greater than or equal to 40 J/g. This enthalpy of fusion may for example be from 20 to 25 J/g; or from 25 to 30 J/g; or from 30 to 35 J/g; or from 35 to 40 J/g; or from 40 to 45 J/g; or from 45 to 50 J/g; or from 50 to 55 J/g; or from 55 to 60 J/g.

With respect to the enthalpy of fusion of the polyamide blocks of the PEBA (for example in the form of granules) which is used as starting material for the manufacture of the powder of the invention, the enthalpy of fusion of the polyamide blocks of the PEBA in powder form according to the invention itself is:
greater (in relative value) by at least 10%, preferably by at least 20%, or by at least 30%, or by at least 40%, or by at least 50%, or by at least 60%, or by at least 70%, or by at least 80%, or by at least 90%, or by at least 100%; or
greater (in absolute value) by at least 10 J/g, preferably by at least 15 J/g, or by at least 20 J/g, or by at least 30 J/g, or by at least 40 J/g, or by at least 50 J/g.

The PEBA powder may in particular be in the form of spheroidal particles, and preferably possibly spherical particles.

In certain embodiments, the particles of the PEBA powder may have an average size (Dv50) of from 20 to 150 μm, and preferably from 40 to 80 μm. For example, the copolymer powder may have a Dv50 size of from 20 to 30 μm; or from 30 to 40 μm; or from 40 to 50 μm; or from 50 to 60 μm; or from 60 to 70 μm; or from 70 to 80 μm; or from 80 to 90 μm; or from 90 to 100 μm; or from 100 to 110 μm; or from 110 to 120 μm; or from 120 to 130 μm; or from 130 to 140 μm; or from 140 to 150 μm.

The particle size distribution by volume of the powders is determined according to a standard technique, for example using a Coulter Counter III particle size analyzer, according to the standard ISO 13320-1: 1999. From the particle size distribution by volume, it is possible to determine the volume average diameter (Dv50) and also the particle size dispersion (standard deviation) which measures the width of the distribution.

The term Dv50 denotes the 50th percentile of the size distribution of the 35 particles, that is to say that 50% of the particles have a size less than the Dv50 and 50% have a size greater than the Dv50. It is the median of the volumetric distribution of the polymer particles.

In certain embodiments, the PEBA powder has an inherent viscosity of from 1.1 to 1.7, and preferably from 1.3 to 1.5. Thus, the powder may for example have an inherent viscosity of from 1.1 to 1.2; or from 1.2 to 1.3; or from 1.3 to 1.4; or from 1.4 to 1.5; or from 1.5 to 1.6; or from 1.6 to 1.7. In the foregoing, the inherent viscosity is expressed in (g/100 g)⁻¹.

The inherent viscosity is measured using a micro-Ubbelohde tube. The measurement is taken at 20° C. on a 75 mg sample at a concentration of 0.5% (m/m) in m-cresol. The inherent viscosity is expressed in (g/100 g)⁻¹ and is calculated according to the following formula:

Inherent viscosity=ln(tₛ/t₀)×1/C, with C=m/p×100, in which is tₛ the flow time of the solution, t₀ is the flow time of the solvent, m is the mass of the sample whose viscosity is determined and p is the mass of the solvent.

In certain embodiments, the PEBA powder may have a melting temperature of the polyamide blocks of from 130° C. to 210° C., and preferably from 160° C. to 190° C. The copolymer powder may in particular have a melting temperature of the polyamide blocks of from 130° C. to 140° C.; or from 140° C. to 150° C.; or from 150° C. to 160° C.; or from 160° C. to 170° C.; or from 170° C. to 180° C.; or from 180° C. to 190° C.; or from 190° C. to 200° C.; or from 200° C. to 210° C. The melting temperature can be measured according to the standard ISO 11357-3 Plastics—Differential scanning calorimetry (DSC) Part 3.

The melting temperature of the polyamide blocks of the PEBA powder is determined during the first heating. In general, a single melting peak of the polyamide blocks is observed. However, if several melting peaks are observed for the polyamide blocks, in the context of the invention the “melting temperature” means the temperature corresponding to the maximum intensity of the signal in DSC. The enthalpy of fusion takes into account the entirety of the melting of the polyamide blocks.

In certain embodiments, the PEBA powder may have an apparent specific surface area of from 0.1 to 50 m²/g, and preferably from 1 to 10 m²/g. The copolymer powder can therefore have a specific surface area of from 0.1 to 1 m²/g; or from 1 to 5 m²/g; or from 5 to 10 m²/g; or from 10 to 20 m²/g; or from 20 to 30 m²/g; or from 30 to 40 m²/g; or from 40 to 50 m²/g. The apparent specific surface area (SSA) is measured according to the BET (BRUNAUER-EMMET-TELLER) method, known to those skilled in the art. It is notably described in The Journal of the American Chemical Society, volume 60, page 309, February 1938, and corresponds to the international standard ISO 5794/1. The specific surface area measured according to the BET method corresponds to the total specific surface area, i.e. it includes the area formed by the pores.

In certain embodiments, the PEBA powder may have a recrystallization temperature of the polyamide blocks of from 40° C. to 160° C., and preferably from 90° C. to 150° C. The PEBA powder may in particular have a crystallization temperature of the polyamide blocks of from 40° C. to 50° C.; or from 50° C. to 60° C.; or from 60° C. to 70° C.; or from 70° C. to 80° C.; or from 80° C. to 90° C.; or from 90° C. to 100° C.; or from 100° C. to 110° C.; or from 110° C. to 120° C.; or from 120° C. to 130° C.; or from 130° C. to 140° C.; or from 140° C. to 150° C.; or from 150° C. to 160° C. The recrystallization temperature can be measured according to the standard ISO 11357-3.

The recrystallization temperature of the polyamide blocks is determined during the first cooling. In principle, only one recrystallization temperature is observed.

The PEBA powder can further comprise additives or fillers. Among these compounds, mention is made of reinforcing fillers, in particular mineral fillers such as carbon black, carbon or non-carbon nanotubes, milled or non-milled fibers (glass fibers, carbon fibers, etc.), stabilizers (light, in particular UV, stabilizers and heat stabilizers), optical brighteners, dyes, pigments, energy-absorbing additives (including UV absorbers) or a combination of these fillers or additives.

The additives can be mixed with the copolymer before the powder manufacturing process, during the powder manufacturing process (for example after having dissolved the copolymer and before precipitating it), or after the powder manufacturing process. Preferably, the additives are introduced after the powder manufacturing process, by mixing between the PEBA powder and said additives.

The powder may comprise the PEBA copolymer(s) in a weight proportion preferably of greater than or equal to 80%, or 81%, or 82%, or 83%, or 84%, or 85%, or 86%, or 87%, or 88%, or 89%, or 90%, or 91%, or 92%, or 93%, or 94%, or 95%, or 96%, or 97%, or 98%, or 99%, or 99.1%, or 99.2%, or 99.3%, or 99.4%, or 99.5%, or 99.6%, or 99.7%, or 99.8%, or 99.9%, or 99.91%, or 99.92%, or 99.93%, or 99.94%, or 99.95%, or 99.96%, or 99.97%, or 99.98%, or 99.99%.

### Process for Sintering the Powder

The PEBA powder, as described above, is used for a process for layer-by-layer construction of three-dimensional articles by sintering brought about by electromagnetic radiation.

The electromagnetic radiation may be, for example, infrared radiation, ultraviolet radiation or preferably laser radiation.

According to the process, a thin layer of powder is deposited on a horizontal plate maintained in an enclosure heated to a temperature referred to as the construction temperature. The term “construction temperature” denotes the temperature to which the bed of powder, of a constituent layer of a three-dimensional object under construction, is heated during the process for layer-by-layer sintering of the powder. This temperature may be lower than the melting temperature of the polyamide blocks of the PEBA powder by less than 100° C., preferably by less than 40° C., and more preferably by approximately 20° C. The electromagnetic radiation then provides the energy needed to sinter the powder particles at various points of the powder layer in a geometry corresponding to an object (for example using a computer having, in memory, the shape of an object and reproducing the shape in the form of slices).

Next, the horizontal plate is lowered by a value corresponding to the thickness of one powder layer, and a new layer is deposited. The electromagnetic radiation provides the energy needed to sinter the powder particles in a geometry corresponding to this new slice of the object and so on. The procedure is repeated until the object has been manufactured.

### Example

The example that follows illustrates the invention without limiting it.

In this example three different types of PEBA are used:
PEBA 1 (PA12/PTMG weight ratio=8);
PEBA 2 (PA11/PTMG weight ratio=9).

5 g of PEBA and 25 g of technical-grade ethanol (solids=17%) are loaded into an autoclave equipped with a propeller-type stirrer. The medium is heated using a removable oven up to 145° C. and maintained at this temperature for one hour to solubilize the PEBA. Next, the oven is removed from the reactor in order to cool the medium and enable the crystallization, and after draining at 40-50° C., the polymer powder is dried at 75° C. in the drying oven (under atmospheric pressure).
PEBA 3 (PA12/PTMG weight ratio=2).

37.5 g of PEBA and 375 g of technical-grade ethanol (solids=9%) are loaded into an autoclave equipped with a propeller-type stirrer. The medium is heated using the jacket up to 120° C. and maintained at this temperature for one hour to solubilize the PEBA. Next, the medium is cooled slowly at 10° C./h down to 80° C., and after draining at 20-30° C., the polymer powder is dried under vacuum at room temperature (this test was repeated twice).

The results obtained for the PEBA powders are compared with the results obtained for the initial PEBA granules.

The three tests led to the production of a polymer powder.

Analysis of the inherent and infrared viscosity shows that there was no depolymerization by alcoholysis, neither of the ester functions nor of the amide functions.

Furthermore, the DSC analysis shows that this process promotes the crystallization, by refining the melting peak and by increasing the crystallinity, given that the enthalpy of fusion is around two times greater for the powder than for the granules.

TABLE 1

| PEBA | | | Inherent | | |
|---|---|---|---|---|---|
| no. | Form | Particle size | viscosity | Tₘ | ΔH_{f} |
| 1 | powder | 60 μm | 1.42 | 176° C. | 105 J/g |
| 1 | granules | — | 1.46 | 171° C. | 58 J/g |
| 2 | powder | 52 μm | 1.36 | 185° C. | 97 J/g |
| 2 | granules | — | 1.37 | 184° C. | 56 J/g |
| 3 | powder | 30 μm | 1.46 | 159° C. | 59 J/g |
| 3 | powder | 32 μm | 1.48 | 159° C. | 65 J/g |
| 3 | granules | — | 1.49 | 158° C. | 41 J/g |

For PEBA powders, the melting temperature of the polyamide blocks (Tₘ) and the enthalpy of fusion of the polyamide blocks (ΔH_{f}) are determined during the first heating; whereas for granules, the melting temperature of the polyamide blocks (Tₘ) and the enthalpy of fusion of the polyamide blocks (ΔH_{f}) are determined during the second heating.

1. A copolymer powder containing polyamide blocks and polyether blocks having:
an enthalpy of fusion of the polyamide blocks of greater than or equal to 70 J/g if the weight ratio of the polyamide blocks relative to the polyether blocks of the copolymer is greater than or equal to 4;
an enthalpy of fusion of the polyamide blocks of greater than or equal to 50 J/g if the weight ratio of the polyamide blocks relative to the polyether blocks of the copolymer is greater than or equal to 1 and less than 4; or
an enthalpy of fusion of the polyamide blocks of greater than or equal to 20 J/g if the weight ratio of the polyamide blocks relative to the polyether blocks of the copolymer is less than 1.

2. The powder as claimed in claim 1, wherein the polyamide blocks of the copolymer are blocks of polyamide 11, or of polyamide 12, or of polyamide 6, or of polyamide 10.10, or of polyamide 10.12, or of polyamide 6.10; and/or wherein the polyether blocks of the copolymer are blocks of polyethylene glycol or of polytetrahydrofuran.

3. The powder as claimed in claim 1, wherein the polyamide blocks have a number-average molar mass of from 600 to 6000; and/or wherein the polyether blocks have a number-average molar mass of from 250 to 2000.

4. The powder as claimed in claim 1, wherein the weight ratio of the polyamide blocks relative to the polyether blocks of the copolymer is from 2 to 19.

5. The powder as claimed in claim 1, being in the form of spheroidal particles having a Dv50 size of from 20 to 150 μm.

6. The powder as claimed in claim 1, wherein the copolymer containing polyamide blocks and polyether blocks comprises ester bonds between the polyamide blocks and the polyether blocks.

7. The powder as claimed in claim 1, having an enthalpy of fusion of the polyamide blocks of greater than or equal to 70 J/g.

8. A process for manufacturing a powder as claimed in claim 1, comprising:
supplying a copolymer containing polyamide blocks and polyether blocks;
bringing the copolymer into contact with a solvent in order to obtain a mixture;
heating the mixture in order to dissolve the copolymer in the solvent; and
cooling the mixture in order to obtain a precipitated copolymer in powder form.

9. The process as claimed in claim 8, wherein the solvent which is brought into contact with the copolymer is ethanol.

10. The process as claimed in claim 8, wherein the heating of the mixture is carried out at a temperature of from 100° C. to 160° C.; and/or wherein the heating of the mixture has a duration of from 1 to 6 hours.

11. The process as claimed in claim 8, wherein the cooling of the mixture is carried out at a rate of 10° C. to 100° C. per hour.

12. The process as claimed in claim 8, wherein an amount of polyamide, not exceeding 20% by weight of the copolymer, is introduced before the cooling of the mixture.

13. The process as claimed in claim 8, further comprising a step of drying the copolymer powder after the cooling of the mixture.

14. The process as claimed in claim 13, wherein the drying of the copolymer powder is carried out at a pressure of from 10 mbar to atmospheric pressure.

15. The use of the powder as claimed in claim 1, for the layer-by-layer construction of a three-dimensional article by sintering of the powder brought about by electromagnetic radiation.

16. A three-dimensional article manufactured from the powder as claimed in claim 1.
